(19) United States
(12) Patent Application Publication
(10) Pub. No.: US 2026/0259295 A1
(43) Pub. Date: Sep. 3, 2026

(54) HIGH ACCURACY DIRECTION FINDING ANTENNA BASED ON TDOA

(71) Applicant: Swift Beat, LLC, Menlo Park, CA (US)

(72) Inventors: Joseph A. KAISER, JR., Hopkinton, MA (US); Sanghoon LEE, Concord, MA (US)

(21) Appl. No.: 19/553,330

(22) Filed: Feb. 28, 2026

Related U.S. Application Data
(60) Provisional application No. 63/766,372, filed on Mar. 3, 2025.

(51) Int. Cl. G01S 5/04; H01Q 21/00

(52) U.S. Cl. CPC G01S 5/04; H01Q 21/00

(57) ABSTRACT

A system includes an antenna array. The antenna array includes a plurality of antennas, wherein no two antennas of the plurality of antennas share a common y-coordinate or a common z-coordinate. The system includes a processor and a memory including computer program code. The memory and the computer program code are configured to cause the processor to receive signal data associated with a signal from the antenna array, generate a direction-finding (DF) result using a DF algorithm and the received signal data, and determine a location of a source of the signal using the generated DF result.

### CROSS-REFERENCE TO RELATED APPLICATIONS

This non-provisional utility application claims priority to provisional patent application No. 63/766,372, entitled “HIGH ACCURACY DIRECTION FINDING ANTENNA BASED ON TDOA” and filed on Mar. 3, 2025, which is incorporated herein in its entirety by reference.

### BACKGROUND

Existing antenna arrays used for direction finding (DF) are usually constructed as circular, uniform linear arrays (ULA), or other phased-array arrangements often employing non-equally spaced antenna elements but still resulting in symmetrical construction about the two axes orthogonal to the direction of propagation from an emitter location of interest. These arrays typically employ a multitude of individual antenna elements where their symmetrical horizontal or vertical locations create redundancies of time difference of arrivals (TDOAs) such that determining an orthogonal axis direction is impossible unless the other complementary orthogonal axis antennas are also present. These structures cannot make the best use of their antenna locations since some share the same coordinate location values or planes, thereby providing redundant information. This results in less than full TDOA information from being determined from the fewest number of antenna elements.

### SUMMARY

In one aspect, a system includes an antenna array. The antenna array includes a plurality of antennas, wherein no two antennas of the plurality of antennas share a common y-coordinate or a common z-coordinate. The system includes a processor and a memory including computer program code. The memory and the computer program code are configured to cause the processor to receive signal data associated with a signal from the antenna array, generate a direction-finding (DF) result using a DF algorithm and the received signal data, and determine a location of a source of the signal using the generated DF result.

In another aspect, a computerized method includes: receiving a signal using an antenna array, wherein the received signal is received from a region; generating a first direction-finding (DF) result using a DF algorithm and the received signal; projecting the received signal onto an axis to form a projected signal; generating a second DF result using the DF algorithm and the projected signal; combining the first DF result and the second DF result to form a combined DF result; and determining a location of a source of the received signal in the region using the combined DF result.

In another aspect, a computer storage medium has computer-executable instructions that, upon execution by a processor, cause the processor to at least: receive a signal using a diagonal antenna array, wherein the received signal is received from a region, wherein the diagonal antenna array includes a plurality of antennas and no two antennas of the plurality of antennas overlap on a first axis, wherein no two antennas of the plurality of antennas overlap on a second axis; generate a first direction-finding (DF) result using a DF algorithm and the received signal; project the received signal onto the first axis to form a projected signal; generate a second DF result using the DF algorithm and the projected signal; combine the first DF result and the second DF result to form a combined DF result; and determine a location of a source of the received signal in the region using the combined DF result.

### BRIEF DESCRIPTION OF THE DRAWINGS

FIG. 1 is a block diagram illustrating an example system for determining the location of a signal source according to an implementation.

FIG. 2 is a flowchart illustrating a method for determining the location of a signal source according to an implementation.

FIG. 3 is a schematic diagram of an example diagonal antenna array of the system shown in FIG. 1 according to an implementation.

FIG. 4 is a schematic diagram illustrating example arrangements of antenna arrays around a fuselage of an aircraft according to an implementation.

FIG. 5 includes perspective views of an example diagonal antenna array according to an implementation.

FIG. 6 includes graphs that plot the measurement of the three phase-delta pairs with respect to a reference antenna element for a 180-degree azimuth sweep according to an implementation.

FIG. 7 illustrates example heat maps of a diagonal antenna array according to an implementation.

FIG. 8 illustrates example heat maps of a diagonal antenna array according to an implementation.

FIG. 9 illustrates example heat maps of a diagonal antenna array according to an implementation.

FIG. 10 illustrates a comparison of performance between three candidate arrays according to an implementation.

FIG. 11 illustrates a comparison of performance between three candidate arrays according to an implementation.

FIG. 12 is a flowchart illustrating a method of operation of the system shown in FIG. 1 according to an implementation.

FIG. 13 is a flowchart illustrating a method of operation of the system shown in FIG. 1 according to an implementation.

FIG. 14 is a schematic diagram illustrating an exemplary operating environment of the disclosure according to an implementation.

### DETAILED DESCRIPTION

Existing antenna arrays used for direction finding (DF) are usually constructed as circular, uniform linear arrays (ULA), or other phased-array arrangements often employing non-equally spaced antenna elements but still resulting in symmetrical construction about the two axes orthogonal to the direction of propagation from an emitter location of interest. These arrays typically employ a multitude of individual antenna elements where their symmetrical horizontal or vertical locations create redundancies of time difference of arrivals (TDOAs) such that determining an orthogonal axis direction is impossible unless the other complementary orthogonal axis antennas are also present. These structures cannot make the best use of their antenna locations since some share the same coordinate location values or planes, thereby providing redundant information. This results in less than full TDOA information from being determined from the fewest number of antenna elements.

In contrast, the systems disclosed herein provide the technical solution of every individual antenna element having unique positional coordinates, which enables the technical effect of allowing each individual antenna element to contribute to TDOA determination. That is, two or more antennas do not share identical locations along any positional axis. A variety of array structures are disclosed herein, though the disclosure is not limited to these examples.

Additionally, some examples of the disclosed systems provide the technical solution of the antenna elements, or antennas, being separated such that they are spaced by λ/2 (half the wavelength of the frequency of interest) when projected onto each orthogonal axis. This achieves the technical effect of an improved (e.g., ideal, etc.) trade-off between side lobe suppression and beamwidth of the main lobe as is typical for broadside transmission phased-array design. Other separations are possible. Furthermore, equidistant spacing of λ/2 results in the smallest physical structure that meets the above requirements.

MUSIC (MUltiple SIgnal Classification) is an algorithm frequently used for frequency estimation and radio direction finding. Using this algorithm provides the user with the ability to both identify and track unknown signal sources. The disclosed antenna array has the technical solution of separation and uniqueness of antenna element locations to provide the technical effect of providing as much time and/or phase discrimination as possible by geometrical separation. The technical solution of the disclosed unique coordinate separation between the antenna element cell locations provides for the technical effect of improved direction-finding results. Further, in some examples, the antennas used include loop antennas, Vivaldi antennas, metamaterial antennas, dipole antennas, phase antennas, and/or the like without departing from the disclosure. In some examples, antenna elements and the associated array include a dual-polarized antenna, enabling the resolution of y-axis and z-axis processing simultaneously.

In an example, signal data from the sensed signals is processed via MUSIC with the nominal diagonal array coordinates. Then, one or more separate MUSIC calculations are performed using one or more projections (e.g., a mathematical transformation) of the same captured signal data, which creates a ‘pseudo-linear array’ of the diagonal antenna elements onto one or more axes (e.g., two orthogonal axes to the axis along which the signal is received, etc.). In some examples, the axes are the horizontal and vertical orientations of the antenna and/or platform onto which the array is mounted. The technical solution of performing the MUSIC algorithm at least twice using the described mathematical projection in this example provides the technical effect of enabling the direction-finding calculations to be better (e.g., optimally, etc.) configured with the fewest individual antennas.

For example, a candidate DF antenna array is first characterized for its ability to accurately represent the TDOA between antennas. This is done by calculating and comparing the ideal time/phase differences between signal reception at each antenna with respect to a designated reference antenna within the array as a function of steering angle to the emitter target to be identified. Then the MUSIC algorithm is executed using predetermined azimuth and elevation scan angles. The direction/location where the MUSIC signal-to-noise ratio (SNR) function peaks indicates the location of the target. In some of the figures herein, this is shown as a central zone for this specific target location of Az=90 deg./El=90 deg. As the target moves around and the MUSIC function is recalculated, the peak zone also correspondingly shifts to match the new target location.

Some aspects of the disclosure utilize the technical solution of a diagonal antenna array mounted on a mobile platform or stationary platform. Signal data from the sensed signals at each antenna are the inputs to the MUSIC algorithm, the MUSIC algorithm is executed using the signal data (and projected signal data as described herein), and the outputs are relatively high accuracy location positions (or steering vectors) to one or more source emitters. The MUSIC algorithm is performed or otherwise run multiple times on the same captured dataset to extract the technical effect of the optimal steering vector resolution for any finite number of antennas.

In some examples, one or more of the systems disclosed herein includes, is part of, is a component of, is used with, is implemented in, and/or is associated with a platform, such as, but not limited to, a mobile platform, a stationary platform, and/or the like. For example, the system 100 disclosed herein, in some examples, is configured for use onboard a platform. In some examples, one or more of the systems disclosed herein is used with (e.g., onboard, onboard control, remote from, remote control, etc.) one or more uncrewed, autonomous platforms.

Examples of mobile platforms include, but are not limited to, uncrewed vehicles, uncrewed aerial vehicles (UAVs), aircraft (e.g., rotorcraft, fixed wing aircraft, airplanes, gliders, lighter-than-air craft, balloons, high-altitude balloons, UAVs, etc.), ground vehicles (e.g., land vehicles, automobiles, trucks, cars, electric vehicles, etc.), uncrewed ground vehicles (UGVs), marine vehicles (e.g., boats, ships, etc.), surface vehicles, submersibles, uncrewed marine vehicles (UMVs), uncrewed surface and/or submersible vehicles (USVs), space-based platforms (e.g., cubesats, etc.), suborbital vehicles, vehicles that operate in orbit, platforms carried by an individual (e.g., a backpack and/or other carrying pack, etc.), animals (e.g., a flying animal such as a bird and/or insect, a land animal, a marine animal, etc.), missiles, rockets, uncrewed mobile platforms, autonomous mobile platforms, and/or the like. As used herein, one or more of the systems disclosed herein may be used onboard a mobile platform while the mobile platform is moving and/or while the mobile platform is stationary.

Examples of stationary platforms include, but are not limited to, stations, arrays, central controls, centralized control stations, towers, cellular towers, fixed positions, fixed structures, stationary vehicles, uncrewed stationary platforms, autonomous stationary platforms, buildings, emplacements, installations, ground-based installations, forts, prisons, government locations, government buildings, stadiums, parks, public spaces, infrastructure, dams, public venues, private venues, concert venues, sporting venues, and/or the like.

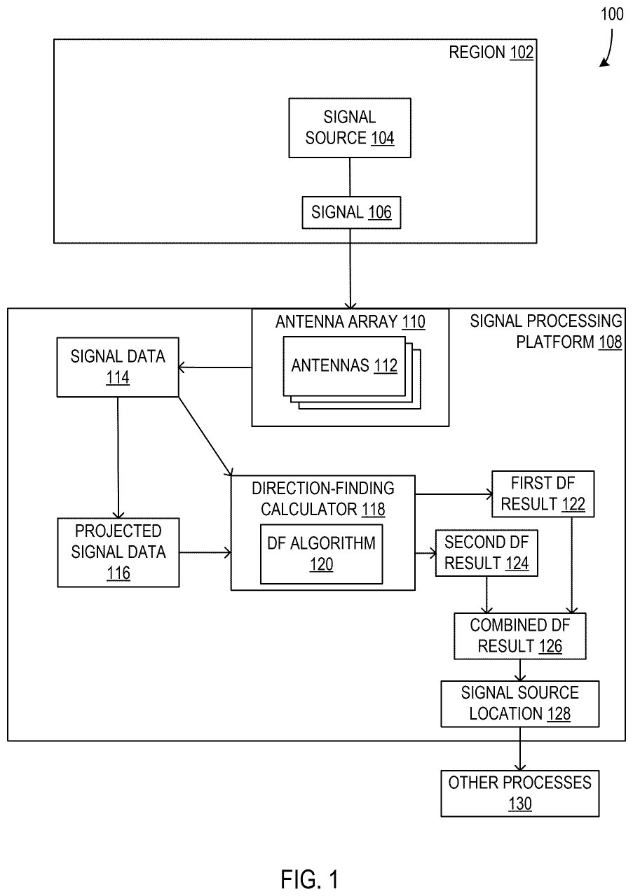

FIG. 1 is a block diagram illustrating an example system 100 for determining the location of a signal source 104 using an antenna array 110 of a signal processing platform 108. In some examples, the signal source 104 is located in a region 102 and emits a signal 106 (e.g., a radio frequency (RF) signal, etc.). The emitted signal is received by the antenna array 110 of the signal processing platform 108, wherein some or all of the antennas 112 of the antenna array 110 receive the signal 106. In some such examples, the antennas 112 are arranged in such a way that none of the antennas overlap each other in at least two axes (e.g., no antenna 112 shares x-coordinates or y-coordinates with any other antenna 112, etc.). In an example, the antenna array 110 is a diagonal antenna array as described herein.

The signal processing platform 108 obtains signal data 114 based on the signal 106. The signal data 114 includes data that describes aspects and/or details of the received signal 106 as received by each of the antennas 112 of the antenna array 110, including timing data for the reception of the signal 104 by each antenna 112. In some such examples, the timing data is used by the direction-finding (DF) calculator 118 when performing the DF algorithm 120 (e.g., calculation, operation, function, logic, etc.). Additionally, in some examples, the signal processing platform 108 projects the signal data 114 onto another axis. For example, the signal data 114 based on the original arrangement of antennas is projected on the horizontal axis that is parallel to the ground. The resulting projected signal data 116 is also used with the DF calculator 118 as described herein.

Further, in some examples, the signal data 114 is analyzed by the DF calculator 118 using the DF algorithm 120 (e.g., the MUSIC algorithm) to generate the first DF result 122. In some such examples, the first DF result 122 includes a heat map that indicates a curve and/or band that includes the location of the signal source 104 in the associated region 102. Additionally, the projected signal data 116 is analyzed by the DF calculator 118 using the DF algorithm 120 to generate the second DF result 124. The second DF result 124 also includes a heat map that indicates a curve or band that includes the location of the signal source 104 in the associated region 102.

In some examples, the first DF result 122 and the second DF result 124 are combined into a combined DF result 126. For instance, the first DF result 122 and second DF result 124 include heat maps with curves or bands that include the location of the signal source 104. Upon combining the first DF result 122 and the second DF result 124, the combined DF result 126 includes a heat map with the curves or bands from the first and second DF results 122 and 124 and the location of the signal source 104 is indicated by the location where the curves or bands intersect. The combined DF result 126 is then used to determine the signal source location 128 and the determined signal source location 128 is used with other processes 130.

In some examples, the other processes 130 include processes that use the determined signal source location 128. For instance, in an example, the other processes 130 include a mapping process that records the locations of signal sources on a map that can then be used to observe the relative locations of the signal sources and/or locations of other entities in a geographic area. Additionally, or alternatively, the other processes 130 include a navigation process that enables a vehicle or other entity to determine how to navigate to the location of the signal source. In such examples, the other processes 130 are performed using computational resources on the signal processing platform 108 (e.g., a mobile platform, a stationary platform, etc.).

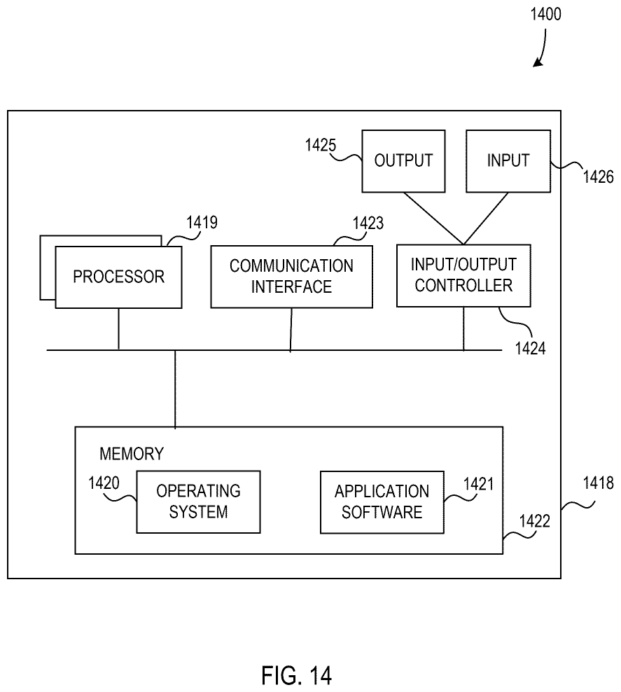

Alternatively, in some examples, the system 100 includes one or more computing devices (e.g., the computing apparatus 1400 of FIG. 14, etc.) that are configured to communicate with each other via one or more communication networks (e.g., an intranet, the Internet, a cellular network, other wireless network, other wired network, or the like). In some examples, entities of the system 100 are configured to be distributed between the multiple computing devices and to communicate with each other via network connections. For example, signal processing platform 108 is associated with a first computing device and one or more of the other processes 130 are performed on a second computing device within the system 100. The first computing device and second computing device are configured to communicate with each other via network connections. Alternatively, in some examples, other components of the signal processing platform 108 (e.g., a component that projects the signal data 114 to generate the projected signal data 116 and/or a component that combines the first DF result 122 and the second DF result 124 into the combined result 126, etc.) are executed on separate computing devices and those separate computing devices are configured to communicate with each other via network connections during the operation of the signal processing platform 108. In other examples, other organizations of computing devices are used to implement system 100 without departing from the description.

In some examples, the antenna array is attached to a mobile platform which moves and/or changes orientation. During movement and/or maneuvering of the device, signals received by the antenna array may be received in an orientation that renders the received signals unusable for determining the location of the signal source as described herein. For instance, if an aircraft to which the antenna array is attached banks steeply, the angle of the antenna array changes drastically with respect to the ground and signals received during the banking maneuver cannot be used to accurately determine the signal source location. In some such examples, during the processing of received signals, the system 100 determines the subset of received signals that have been received during a banking maneuver and/or other similar change in orientation of the antenna array and removes that subset of received signals from the received signals that are used to determine the location of the signal source.

While described in some examples with reference to the MUSIC algorithm, aspects of the disclosure are operable with any direction-finding algorithm based on TDOA.

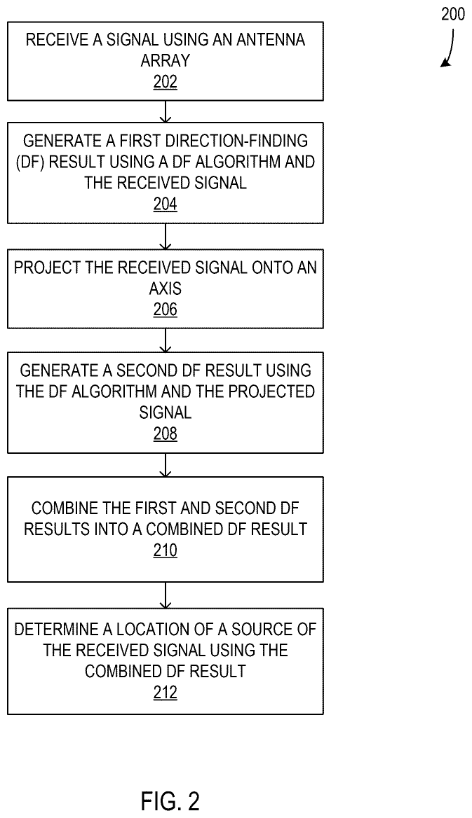

FIG. 2 is a flowchart that illustrates an example method 200 for determining the location of a signal source using an antenna array. In some examples, the method 200 is executed or otherwise performed in a system such as system 100 of FIG. 1.

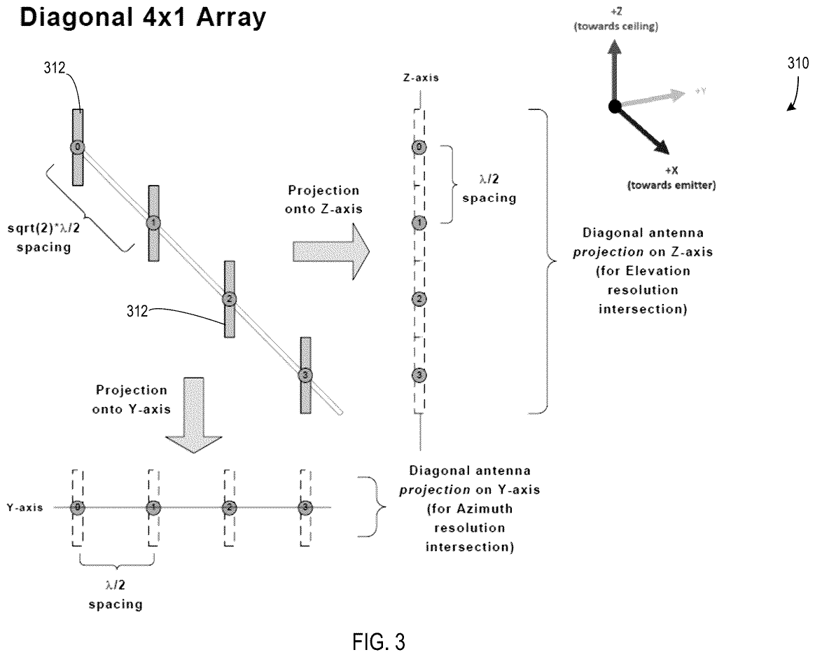

At 202, a signal (e.g., signal 106, etc.) is received using an antenna array (e.g., antenna array 110, etc.). In some examples, the signal is an RF signal emitted by a signal source (e.g., signal source 104, etc.) that is located somewhere in a region (e.g., region 102, etc.) that is being observed by the antenna array. Further, in some examples, the antenna array includes a plurality of antennas (e.g., antennas 112, 312, 412, 512, etc.) that are arranged in a diagonal formation or otherwise, such that no antenna of the antenna array shares y-coordinates or z-coordinates with any other antenna of the antenna array, wherein the y-coordinates are associated with the horizontal axis of the ground and the z-coordinates are associated with the vertical axis that is orthogonal to the horizontal axis. As illustrated in FIG. 3, the y-axis and z-axis are both orthogonal to the x-axis which represents the direction from which the signal 106 is received.

At 204, a first DF result (e.g., first DF result 122) is generated using the DF algorithm (e.g., DF algorithm 120, etc.) and data from the received signal. Optionally, the received signal may first be projected onto an axis (e.g., a vertical or horizontal axis, a vertical or horizontal axis relative to the ground, etc.), to create projected signal data (e.g., the projected signal data 116, etc.) which is used by the DF algorithm 120 to generate the first DF result 122.

In some examples, the first DF result includes a heat map with a curve or band that includes the location of the signal source in the region. However, because it is a single curve or band, the location of the signal source is less certain.

At 206, the received signal is projected onto an axis (e.g., a vertical or horizontal axis; a vertical or horizontal axis relative to the ground; another, different, axis from the axis on which the received signal is optionally first projected onto in step 204; etc.) to form a projected signal (e.g., the projected signal is used to generate the projected signal data 116, etc.). In some examples, the axis onto which the received signal is projected onto in step 206 is the y-axis or z-axis as shown in FIG. 3. In examples wherein the first DF result is optionally generated based on projected signal data, then the operation at 206 produces a separate set of projected signal data for use in operation 208.

At 208, a second DF result (e.g., second DF result 124, etc.) is generated using the DF algorithm and the projected signal data. As above, in some examples, the second DF result includes a heat map with a curve or band that includes the location of the signal source in the region. Because the projected signal is associated with a different axis, the curve or band of the second DF result is different than the curve or band of the first DF result.

At 210, the first and second DF results are combined into a combined DF result (e.g., combined DF result 126, etc.). In some examples, the combined DF result includes a heat map with curves or bands from each of the first and second DF results. At 212, the location of the source of the received signal is determined using the combined DF result. In some examples, the location is determined based on the intersection of the curves or bands on the heat map of the combined DF result.

While many examples herein describe the results of the DF processes including heat maps, in other examples, the results include other representations instead of or in addition to heat maps, such as, but not limited to, mathematical equations and/or other methods of representing the results in non-graphical ways. In some such examples, intersections of the two DF results can still be used to determine the location of the signal source without departing from the description. Any of the heat maps disclosed herein may be referred to herein as a “first”, a “second”, and/or a “third” heat map.

Further, in some examples, a third DF result is generated using projected signal data that has been projected onto another, different, axis. For example, if the axis projected onto at step 206 is the y-axis, then the axis projected onto to generate the third DF result may be the z-axis. In another example, if the axis projected onto at step 206 is the z-axis, then the axis projected onto to generate the third DF result may be the y-axis. In such examples, the third DF result is combined with the first and second DF results to form the combined DF result. Any of the axes disclosed herein may be referred to herein as a “first”, a “second”, and/or a “third” axis.

In still another example, if the projected signal data (e.g., on the y-axis or the z-axis) was used by the DF algorithm to generate the first DF result, then the axis projected onto to generate the third DF result may be the x-axis (e.g., projected into a 3-dimensional volume). In such examples, the combined DF result is a 3-dimensional DF result, such that intersections between the three results in the combined DF result can be used to determine the location of the signal source. In examples involving projection on the x-axis, the antennas are not coplanar with the y-axis and z-axis, but are spaced within the x-axis (e.g., have depth within the x-axis).

Additionally, or alternatively, in some examples, the antenna array includes antennas that are positioned in the antenna array such that the antennas are separated by a freespace wavelength of the antennas divided by two (e.g., λ/2).

Some examples of the disclosed systems include the diagonal antenna array 310 as shown in FIG. 3. In FIG. 3, it can be seen that all four antennas 312 in the array 310 possess unique horizonal and vertical coordinate locations. The phase-delta pairs calculated between any two antennas 312 will be unique and therefore every pair contributes to direction finding. As illustrated, in some examples, the antennas 312 of the antenna array 310 are diagonally spaced by the square root of two multiplied by half the wavelength of the signal of interest (e.g., sqrt(2)*λ/2). This ensures that the spacing of the antennas 312 in either projection is half the wavelength of the signals of interest (e.g., λ/2).

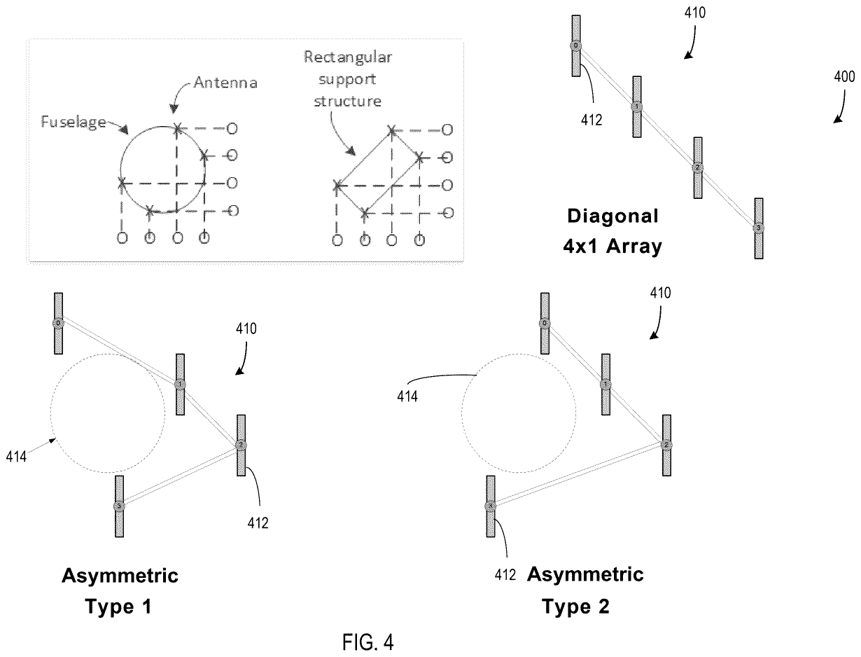

FIG. 4 is a diagram illustrating example arrangements 400 of diagonal antenna arrays 410 and/or equivalent antenna arrays 410 around a fuselage 414 of an aircraft. In addition to the diagonal array 410 as described herein, an asymmetric type 1 array 410 and asymmetric type 2 array 410 are illustrated. Each array 410 includes antennas 412 that are arranged in such a way that they do not share coordinates associated with two different orthogonal axes. In other examples, other arrangements of antennas 412 are used to form an antenna array 410 without departing from the description.

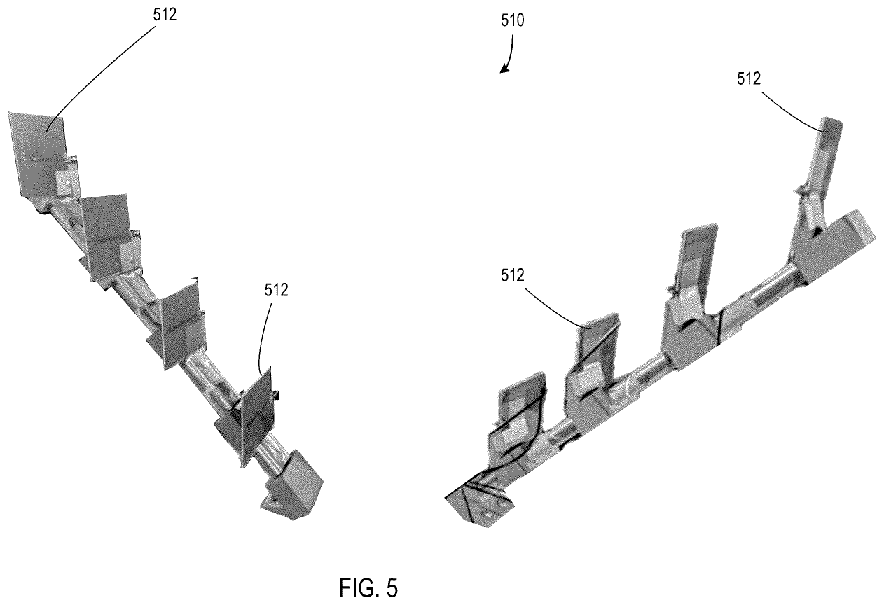

FIG. 5 is a perspective view illustrating an example diagonal antenna array 510 from two different orientations. The example diagonal antenna array 510 includes four antennas 512 that are arranged and spaced as described herein.

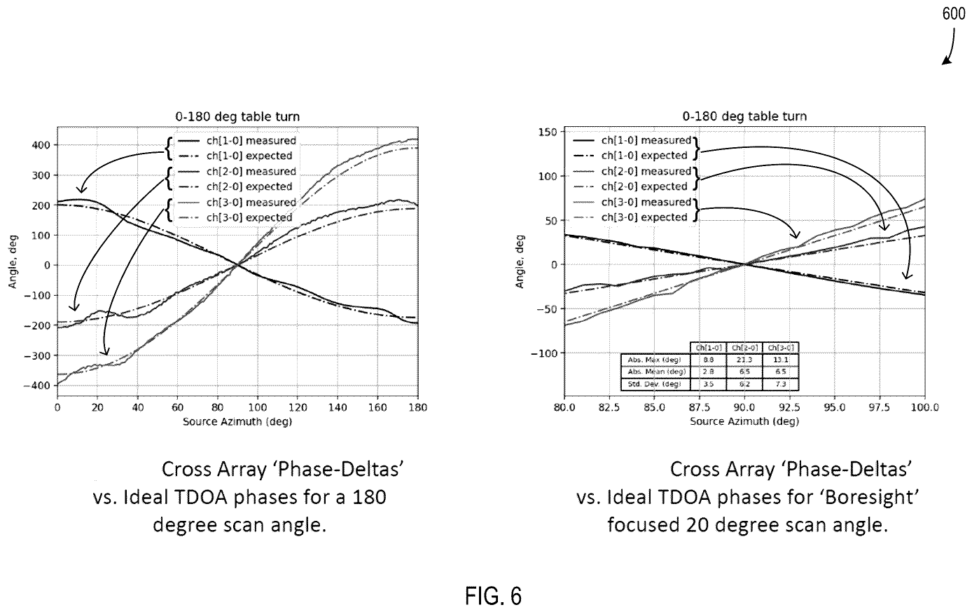

The measurement of the three phase-delta pairs with respect to a reference antenna element for a 180-degree azimuth sweep is shown in the graphs 600 of FIG. 6. The plots of the graphs 600 shown in FIG. 6 illustrate good agreement with the ideal phase deltas for all three pairs and notably the uniqueness of all three curves. Further, the ‘target zone’ accuracy plot of FIG. 6 is the central zone where the antenna array would be aimed for calibration if ‘boresight’ aiming were the priority. It can be seen that the close-in accuracy is within a few degrees of ideal.

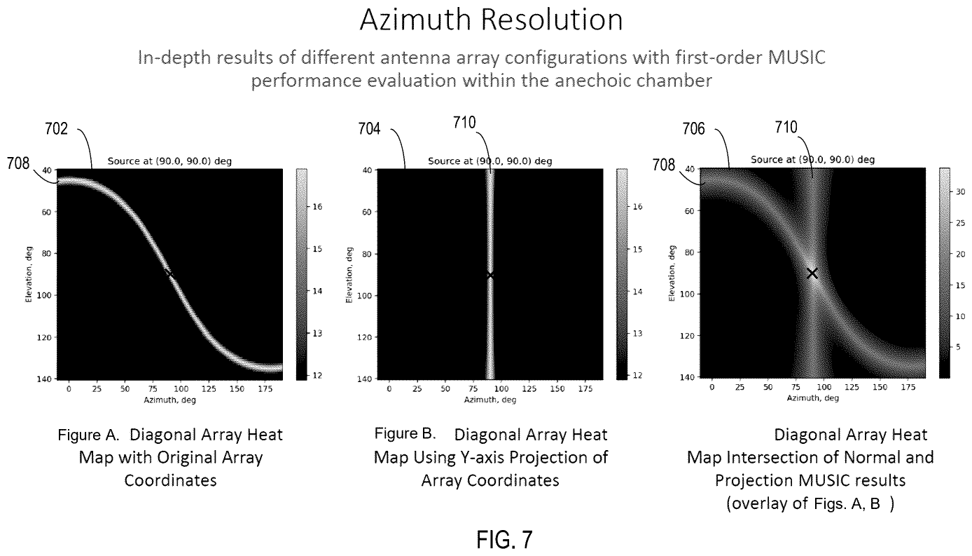

FIG. 7 illustrates a MUSIC algorithm heat map 702 for a diagonal antenna array when the array is swept in an azimuth manner over 180 degrees. Because the diagonal array contains aspects of both horizontal and vertical locations, the solution to coherent phase-deltas from any targets is not unique but rather indicates a full range of equally probable peak locations as shown by the curved line or band 708. This would not provide precise steering angle location alone since any location within the yellow band is an equally valid solution. Therefore, a second MUSIC calculation is performed using the same I/Q dataset (channel captured signals) but on a ‘projection’ of the diagonal array against one axis. In the heat map 704 illustrated in FIG. 7, the calculation is projected against the Y-axis for the correct determination of the azimuth coordinate. This is shown as the vertical band 710 indicating that any value in this zone is equally valid. Again, using this plot alone is insufficient to determine location. Therefore, the heat maps 702 and 704 are combined to create the heat map 706.

Heat map 706 is the composite plot of both MUSIC calculations overlaid. The intersection of these traces is used to correctly determine the target location. The intersection is a small zone, and precisely corresponds to the actual target location as indicated by the ‘X’.

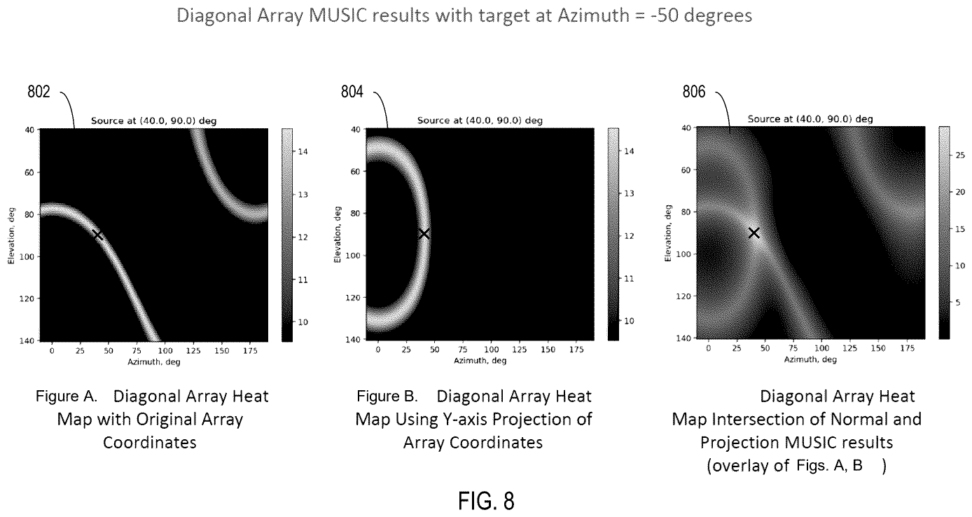

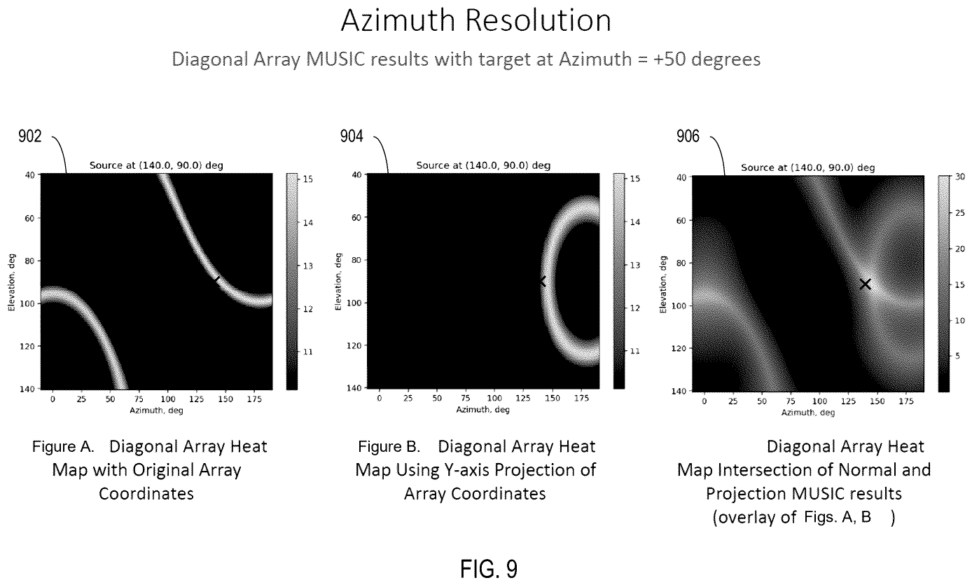

The heat maps 702, 704, and 706 of FIG. 7 illustrate the boresight target zone for this array, which is the easiest to determine with the smallest net error. Two other cases are illustrated in FIGS. 8 and 9, where the target is now shifted off-center by 50 degrees; approaching from the left by 50 degrees in FIG. 8 and to the right by 50 degrees in FIG. 9. The two MUSIC algorithm results are illustrated in heat maps 802 and 804 for FIG. 8 and those two heat maps are combined in heat map 806. The two MUSIC algorithm results are illustrated in heat maps 902 and 904 for FIG. 9 and those two heat maps are combined in heat map 906. Due to the particular geometry of the diagonal array, the solutions are not straight lines in one axis but rather curves that determine equal peak phase coherency. However, it can be seen that the intersections of the illustrated traces indicate the correct target locations as shown in the overlaid heat maps 806 and 906.

It should be understood that, in other examples, the same results in a complementary manner are evident for elevation sweeps and its determination using this two-step process while projecting onto the Z-axis instead.

Importantly, the approach described herein also eliminates false targets (mathematical aliases or ambiguities) where multiple ‘peak’ regions may indicate more than one target or ambiguous locations when only a single target is present.

In some examples, an aspect of the disclosed diagonal antenna includes an extra degree of phase-delta freedom combined with the added step of performing a second MUSIC (or other DF calculation) to yield improved location results over any other array using an equivalent number of antenna elements but with fewer independent phase-delta pairs.

As such, aspects of the disclosure provide wide scan angles with ambiguity resolution within the desired field of regard.

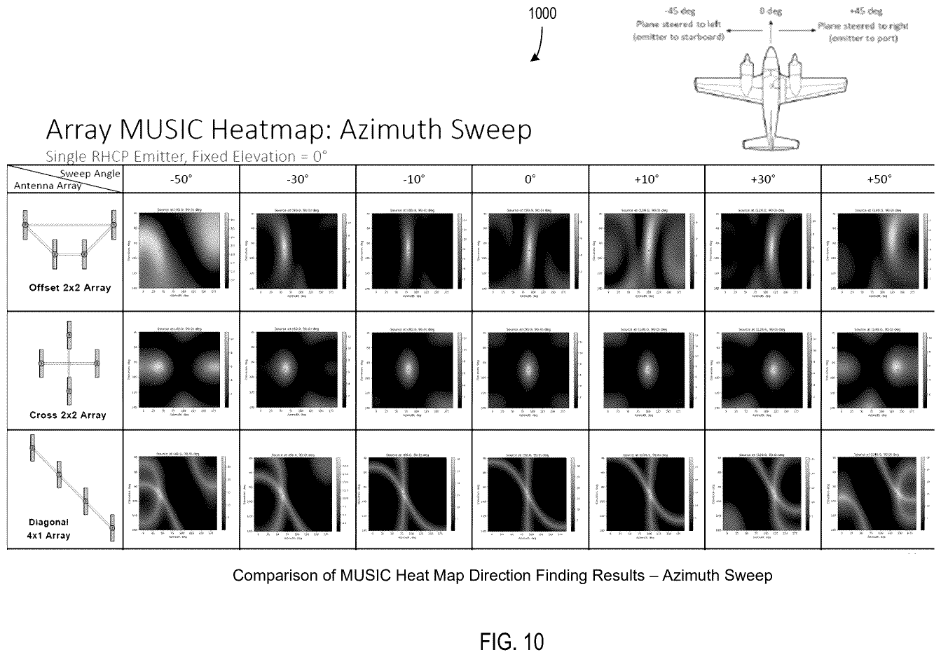

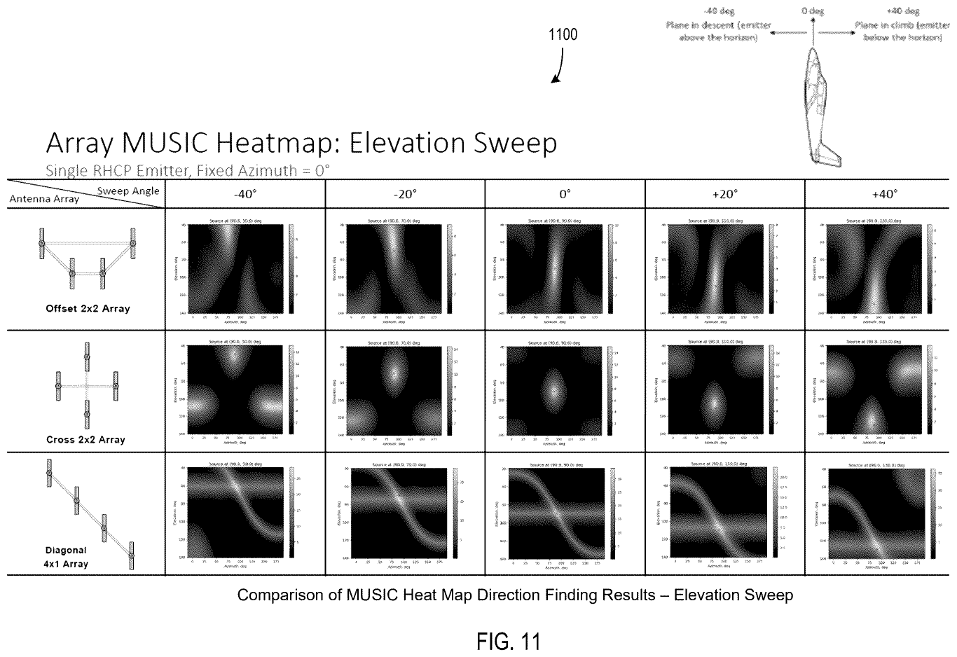

Next, a comparison of performance between three candidate arrays is illustrated in FIGS. 10 and 11. The comparison shown in FIGS. 10 and 11 includes an Offset-Array, a Cross Array, and the Diagonal Array of the present disclosure. The results 1000 and 1100 of FIGS. 10 and 11, respectively, illustrate a number of observations. First, the ‘Offset-Array’ has the poorest performance of the three. This shows washed out, large, and curvy peak zones for target identification. In particular, the elevation resolution of this array is poor since there exists only one phase-delta pair from which to resolve elevation angle, which results in the large vertical smearing for both the azimuth and elevation plots.

The Cross Array shows improved location performance for both azimuth and elevation and all peak zones are circular in nature due to equivalent horizontal and vertical phase-delta pairs (two for each axis). However, the Cross Array shows some location ambiguity for angles significantly away from boresight. For the +/−50-degree plots, there are multiple regions highlighted in yellow which result in undetermined locations. Nonetheless, this is a good candidate for modest scan angles (up to +/−30 degrees).

The ‘combined’ results of both the Normal and Projected MUSIC results are plotted in the disclosed Diagonal Antenna Array plots of FIGS. 10 and 11. This technique results in well-defined intersections extending beyond the scan angle ranges of the previous two arrays. The plots of the Diagonal Antenna Array also illustrates the ability of the disclosed systems to ‘disambiguate’ the location uncertainties evident in the plots of the Offset-Array and the Cross Array. This is true for both azimuth and elevation determinations. In some examples, an aspect of the disclosed diagonal antenna is that it utilizes all four antennas with three unique phase-delta pairs.

The results illustrated in FIGS. 10 and 11 only cover one axis projection in addition to the normal MUSIC algorithm computation. In other examples, the results could be extended to include running the algorithm using both projections (onto the horizontal (Y-axis) and vertical (Z-axis)) and then combining all three results in a single plot to further refine and improve location accuracy.

Referring again to FIG. 1, in some examples, the antenna array 110 includes a plurality of antennas that are coplanar with the y-axis and z-axis as illustrated in FIG. 3 (e.g., and share a common x-axis coordinate). In other examples, the antenna array 110 includes a plurality of antennas 112 that are not coplanar with the y-axis and the z-axis. That is, the antennas 112 have different coordinates on the x-axis, thus resulting in a diagonal arrangement along the x-axis in some examples which enables projection onto the x-axis to obtain projected signal data. Aspects of the disclosure are operable to calculate the combined DF results 126 using any combination of projected signal data on the y-axis, z-axis, and/or x-axis. Including the signal data projected on the x-axis (e.g., projected into a 3D volume) enables a 3-dimensional (3D) DF process.

Additionally, and as a matter of system and algorithm enhancements, in some examples, the intersections of these traces are supplemented with an ‘error region’ calculation that computes the error zone of the highest peak region. This is the peak zone within the top 1 dB (or another threshold as selected by the user). Then a ‘square area’ that contains these values is computed with the peak value assigned as the target location estimate for further signal processing tasks.

Further, though the illustrated examples only depict the results associated with a single emitter, the disclosed antenna and algorithm enhancements extend and applicably apply to situations with multiple emitter detections.

While illustrated and described herein with reference to four antennas, aspects of the disclosure are operable with additional, or fewer, antennas.

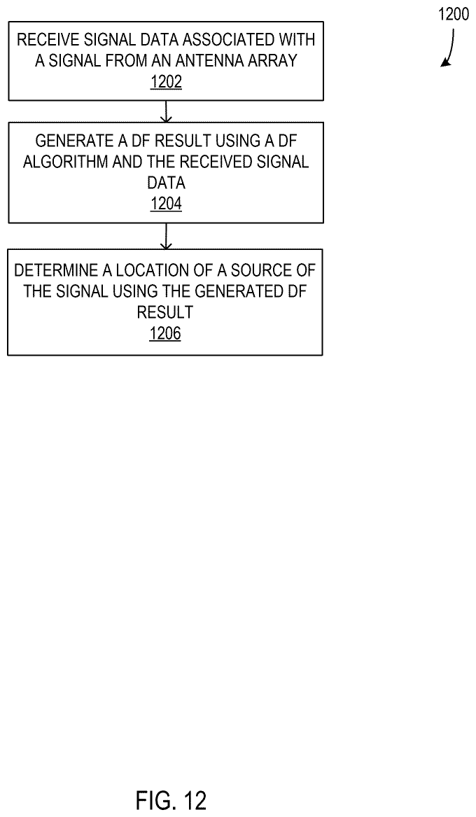

FIG. 12 is a flowchart illustrating an example of a method 1200 of operations, functions, and/or the like of the system 100 (FIG. 1). At 1202, the method 1200 includes receiving signal data associated with a signal from an antenna array. At 1204, the method 1200 includes generating a DF result using a DF algorithm and the received signal data. The method 1200 includes determining, at 1206, a location of a source of the signal using the generated DF result.

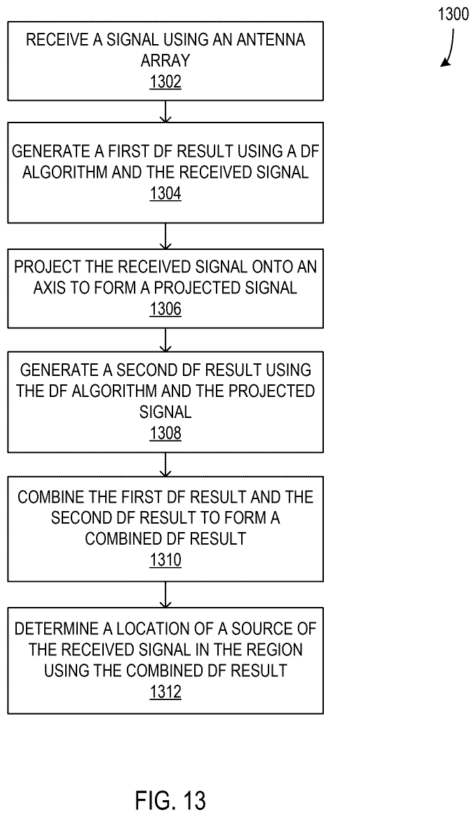

FIG. 13 is a flowchart illustrating an example of a method 1300 of operations, functions, and/or the like of the system 100 (FIG. 1). At 1302, the method 1300 includes receiving a signal using an antenna array, wherein the received signal is received from a region. At 1304, the method 1300 includes generating a first DF result using a DF algorithm and the received signal. At 1306, the method 1300 includes projecting the received signal onto an axis to form a projected signal. The method 1300 includes generating, at 1308, a second DF result using the DF algorithm and the projected signal. The method 1300 includes combining, at 1310, the first DF result and the second DF result to form a combined DF result. At 1312, the method 1300 includes determining a location of a source of the received signal in the region using the combined DF result.

### Exemplary Operating Environment

The present disclosure is operable with a computing apparatus according to an implementation as a functional block diagram 1400 in FIG. 14. In an example, components of a computing apparatus 1418 are implemented as a part of an electronic device according to one or more implementations described in this specification. The computing apparatus 1418 comprises one or more processors 1419 which may be microprocessors, controllers, or any other suitable type of processors for processing computer executable instructions to control the operation of the electronic device. Alternatively, or in addition, the processor 1419 is any technology capable of executing logic or instructions, such as a hard-coded machine. In some examples, platform software comprising an operating system 1420 and/or any other suitable platform software is provided on the apparatus 1418 to enable application software 1421 to be executed on the device. In some examples, determining the location of a signal source using an antenna array as disclosed herein and/or multiple performances of direction-finding algorithms as disclosed herein is accomplished by software, hardware, and/or firmware operating on a single device (e.g., a stationary platform, a mobile platform, etc.) or distributed across multiple devices.

In some examples, computer executable instructions are provided using any computer-readable media that is accessible by the computing apparatus 1418. Computer-readable media include, for example, computer storage media and communications media. Computer storage media, such as a memory 1422, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 1422) is shown within the computing apparatus 1418, it will be appreciated by a person skilled in the art, that, in some examples, the storage is distributed or located remotely and accessed via a network or other communication link (e.g., using a communication interface 1423).

Further, in some examples, the computing apparatus 1418 comprises an input/output controller 1424 configured to output information to one or more output devices 1425, for example a display (e.g., displaying a GUI) or a speaker, which are separate from or integral to the electronic device. Additionally, or alternatively, the input/output controller 1424 is configured to receive and process an input from one or more input devices 1426, for example, a keyboard, a microphone, or a touchpad. In one example, the output device 1425 also acts as the input device. An example of such a device is a touch sensitive display. The input/output controller 1424 may also output data to devices other than the output device, e.g., a locally connected printing device. In some examples, a user provides input to the input device(s) 1426 and/or receives output from the output device(s) 1425.

The functionality described herein can be performed, at least in part, by one or more hardware logic components. According to an implementation, the computing apparatus 1418 is configured by the program code when executed by the processor 1419 to execute the implementations of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, and/or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

Examples may have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Aspects of the disclosure include a system that includes an antenna array. The antenna array includes a plurality of antennas, wherein no two antennas of the plurality of antennas share a common y-coordinate or a common z-coordinate. The system includes a processor and a memory including computer program code. The memory and the computer program code are configured to cause the processor to receive signal data associated with a signal from the antenna array, generate a direction-finding (DF) result using a DF algorithm and the received signal data, and determine a location of a source of the signal using the generated DF result.

In some examples, generating the DF result using the DF algorithm and the received signal data includes: generating a first DF result using the DF algorithm and the received signal data; projecting the received signal data onto an axis to form projected signal data; generating a second DF result using the DF algorithm and the projected signal data; combining the first DF result and the second DF result to form a combined DF result; and wherein determining the location of the source of the signal data using the generated DF result includes determining the location using the combined DF result.

In some examples, combining the first DF result and the second DF result to form a combined DF result further includes: projecting the received signal data onto another axis to form another projected signal data, wherein the axis and the other axis are orthogonal; generating a third DF result using the DF algorithm and the other projected signal data; and combining the first DF result, the second DF result, and the third DF result to form the combined DF result.

In some examples, the first DF result includes a first heat map with a first band indicating a plurality of possible locations of the source of the received signal data; wherein the second DF result includes a second heat map with a second band indicating a plurality of possible locations of the source of the received signal data; wherein the combined DF result includes a third heat map that includes the first band and the second band; and wherein determining the location of the source of the received signal data in a region using the combined DF result includes identifying a portion of the third heat map where the first band and the second band intersect.

In some examples, the memory and the computer program code are configured to further cause the processor to: determine a portion of the received signal data was received during a period when the antenna array was misaligned; filter the determined portion out of the received signal data to form filtered signal data; and utilize the filtered signal data to generate the first DF result and the second DF result.

In some examples, the DF algorithm includes a Multiple Signal Classification (MUSIC) algorithm.

In some examples, the plurality of antennas are positioned in the antenna array such that the antennas are separated by a freespace wavelength of the signals of interest divided by two (λ/2).

Aspects of the disclosure include a computerized method that includes: receiving a signal using an antenna array, wherein the received signal is received from a region; generating a first direction-finding (DF) result using a DF algorithm and the received signal; projecting the received signal onto an axis to form a projected signal; generating a second DF result using the DF algorithm and the projected signal; combining the first DF result and the second DF result to form a combined DF result; and determining a location of a source of the received signal in the region using the combined DF result.

In some examples, the antenna array is a diagonal antenna array including a plurality of antennas and no two antennas of the plurality of antennas overlap on the axis.

In some examples, the DF algorithm includes a Multiple Signal Classification (MUSIC) algorithm.

In some examples, combining the first DF result and the second DF result to form a combined DF result further includes: projecting the received signal onto another axis to form another projected signal, wherein the axis and the other axis are orthogonal; generating a third DF result using the DF algorithm and the other projected signal; and combining the first DF result, the second DF result, and the third DF result to form the combined DF result as a 3D DF result.

In some examples, the antenna array includes a plurality of antennas; and wherein the antennas of the plurality of antennas are positioned in the antenna array such that the antennas are separated by a freespace wavelength of the signals of interest divided by two (λ/2).

In some examples, the first DF result includes a first heat map with a first band indicating a plurality of possible locations of the source of the received signal; wherein the second DF result includes a second heat map with a second band indicating a plurality of possible locations of the source of the received signal; wherein the combined DF result includes a third heat map that includes the first band and the second band; and wherein determining the location of the source of the received signal in the region using the combined DF result includes identifying a portion of the third heat map where the first band and the second band intersect.

In some examples, the method further includes determining a portion of the received signal was received during a period when the antenna array was misaligned; filtering the determined portion out of the received signal to form a filtered signal; and using the filtered signal to generate the first DF result and the second DF result.

Aspects of the disclosure include a computer storage medium has computer-executable instructions that, upon execution by a processor, cause the processor to at least: receive a signal using a diagonal antenna array, wherein the received signal is received from a region, wherein the diagonal antenna array includes a plurality of antennas and no two antennas of the plurality of antennas overlap on a first axis, wherein no two antennas of the plurality of antennas overlap on a second axis; generate a first direction-finding (DF) result using a DF algorithm and the received signal; project the received signal onto the first axis to form a projected signal; generate a second DF result using the DF algorithm and the projected signal; combine the first DF result and the second DF result to form a combined DF result; and determine a location of a source of the received signal in the region using the combined DF result.

In some examples, combining the first DF result and the second DF result to form a combined DF result further includes: projecting the received signal onto another axis to form another projected signal, wherein the axis and the other axis are orthogonal; generating a third DF result using the DF algorithm and the other projected signal; and combining the first DF result, the second DF result, and the third DF result to form the combined DF result as a 3D DF result.

In some examples, the first DF result includes a first heat map with a first band indicating a plurality of possible locations of the source of the received signal; wherein the second DF result includes a second heat map with a second band indicating a plurality of possible locations of the source of the received signal; wherein the combined DF result includes a third heat map that includes the first band and the second band; and wherein determining the location of the source of the received signal in the region using the combined DF result includes identifying a portion of the third heat map where the first band and the second band intersect.

In some examples, the computer-executable instructions, upon execution by a processor, further cause the processor to at least: determine a portion of the received signal was received during a period when the diagonal antenna array was misaligned; filter the determined portion out of the received signal to form a filtered signal; and utilize the filtered signal to generate the first DF result and the second DF result.

In some examples, the DF algorithm includes a Multiple Signal Classification (MUSIC) algorithm.

In some examples, the plurality of antennas are positioned in the diagonal antenna array such that the antennas are separated by a freespace wavelength of the signals of interest divided by two (λ/2).

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one implementation or may relate to several implementations. The implementations are not limited to those that solve any or all of the stated problems or those that have any or all of the stated benefits and advantages. It will further be understood that reference to ‘an’ item refers to one or more of those items.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements. Any of the functions, operations, and/or the like of the systems, methods, and the like disclosed herein are, in some examples, performed automatically by one or more processors, modules, AI engines, models, and/or the like.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation (e.g., different steps) is within the scope of aspects of the disclosure.

The term “comprising” is used in this specification to mean including the feature(s) or act(s) followed thereafter, without excluding the presence of one or more additional features or acts. The terms “comprising,” “including,” and “having” are intended to be inclusive and mean that there can be additional elements other than the listed elements. In other words, the use of “including,” “comprising,” “having,” “containing,” “involving,” and variations thereof, is meant to encompass the items listed thereafter and additional items. Accordingly, and for example, unless explicitly stated to the contrary, implementations “comprising” or “having” an element or a plurality of elements having a particular property can include additional elements not having that property. Further, references to “one implementation” or “an implementation” are not intended to be interpreted as excluding the existence of additional implementations that also incorporate the recited features. The term “exemplary” is intended to mean “an example of”.

When introducing elements of aspects of the application or the examples thereof, the articles “a,” “an,” “the,” and “said” are intended to mean that there are one or more of the elements. In other words, the indefinite articles “a”, “an”, “the”, and “said” as used in the specification and in the claims, unless clearly indicated to the contrary, should be understood to mean “at least one.” Accordingly, and for example, as used herein, an element or step recited in the singular and preceded by the word “a” or “an” should be understood as not necessarily excluding the plural of the elements or steps.

The phrase “one or more of the following: A, B, and C” means “at least one of A and/or at least one of B and/or at least one of C.” The phrase “and/or”, as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” “one of’ “only one of’ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described implementations (and/or aspects thereof) can be used in combination with each other. In addition, many modifications can be made to adapt a particular situation or material to the teachings of the various implementations of the application without departing from their scope. While the dimensions and types of materials described herein are intended to define the parameters of the various implementations of the application, the implementations are by no means limiting and are example implementations. Many other implementations will be apparent to those of ordinary skill in the art upon reviewing the above description. The scope of the various implementations of the application should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various implementations of the application, including the best mode, and also to enable any person of ordinary skill in the art to practice the various implementations of the application, including making and using any devices or systems and performing any incorporated methods. The patentable scope of the various implementations of the application is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
an antenna array, the antenna array including a plurality of antennas, wherein no two antennas of the plurality of antennas share a common y-coordinate or a common z-coordinate;
a processor; and
a memory comprising computer program code, the memory and the computer program code configured to cause the processor to:
receive signal data associated with a signal from the antenna array;
generate a direction-finding (DF) result using a DF algorithm and the received signal data; and
determine a location of a source of the signal using the generated DF result.

2. The system of claim 1, wherein generating the DF result using the DF algorithm and the received signal data includes:
generating a first DF result using the DF algorithm and the received signal data;
projecting the received signal data onto an axis to form projected signal data;
generating a second DF result using the DF algorithm and the projected signal data;
combining the first DF result and the second DF result to form a combined DF result; and
wherein determining the location of the source of the signal data using the generated DF result includes determining the location using the combined DF result.

3. The system of claim 2, wherein combining the first DF result and the second DF result to form a combined DF result further includes:
projecting the received signal data onto another axis to form another projected signal data, wherein the axis and the other axis are orthogonal;
generating a third DF result using the DF algorithm and the other projected signal data; and
combining the first DF result, the second DF result, and the third DF result to form the combined DF result.

4. The system of claim 2, wherein the first DF result includes a first heat map with a first band indicating a plurality of possible locations of the source of the received signal data;
wherein the second DF result includes a second heat map with a second band indicating a plurality of possible locations of the source of the received signal data;
wherein the combined DF result includes a third heat map that includes the first band and the second band; and
wherein determining the location of the source of the received signal data in a region using the combined DF result includes identifying a portion of the third heat map where the first band and the second band intersect.

5. The system of claim 2, wherein the memory and the computer program code are configured to further cause the processor to:
determine a portion of the received signal data was received during a period when the antenna array was misaligned;
filter the determined portion out of the received signal data to form filtered signal data; and
utilize the filtered signal data to generate the first DF result and the second DF result.

6. The system of claim 1, wherein the DF algorithm includes a Multiple Signal Classification (MUSIC) algorithm.

7. The system of claim 1, wherein the plurality of antennas are positioned in the antenna array such that the antennas are separated by a freespace wavelength of the signals of interest divided by two (λ/2).

8. A computerized method comprising:
receiving a signal using an antenna array, wherein the received signal is received from a region;
generating a first direction-finding (DF) result using a DF algorithm and the received signal;
projecting the received signal onto an axis to form a projected signal;
generating a second DF result using the DF algorithm and the projected signal;
combining the first DF result and the second DF result to form a combined DF result; and
determining a location of a source of the received signal in the region using the combined DF result.

9. The computerized method of claim 8, wherein the antenna array is a diagonal antenna array including a plurality of antennas and no two antennas of the plurality of antennas overlap on the axis.

10. The computerized method of claim 8, wherein the DF algorithm includes a Multiple Signal Classification (MUSIC) algorithm.

11. The computerized method of claim 8, wherein combining the first DF result and the second DF result to form a combined DF result further includes:
projecting the received signal onto another axis to form another projected signal, wherein the axis and the other axis are orthogonal;
generating a third DF result using the DF algorithm and the other projected signal; and
combining the first DF result, the second DF result, and the third DF result to form the combined DF result as a 3D DF result.

12. The computerized method of claim 8, wherein the antenna array includes a plurality of antennas; and
wherein the antennas of the plurality of antennas are positioned in the antenna array such that the antennas are separated by a freespace wavelength of the signals of interest divided by two (λ/2).

13. The computerized method of claim 8, wherein the first DF result includes a first heat map with a first band indicating a plurality of possible locations of the source of the received signal;
wherein the second DF result includes a second heat map with a second band indicating a plurality of possible locations of the source of the received signal;
wherein the combined DF result includes a third heat map that includes the first band and the second band; and
wherein determining the location of the source of the received signal in the region using the combined DF result includes identifying a portion of the third heat map where the first band and the second band intersect.

14. The computerized method of claim 8, further comprising:
determining a portion of the received signal was received during a period when the antenna array was misaligned;
filtering the determined portion out of the received signal to form a filtered signal; and
using the filtered signal to generate the first DF result and the second DF result.

15. A computer storage medium has computer-executable instructions that, upon execution by a processor, cause the processor to at least:
receive a signal using a diagonal antenna array, wherein the received signal is received from a region, wherein the diagonal antenna array includes a plurality of antennas and no two antennas of the plurality of antennas overlap on a first axis, wherein no two antennas of the plurality of antennas overlap on a second axis;
generate a first direction-finding (DF) result using a DF algorithm and the received signal;
project the received signal onto the first axis to form a projected signal;
generate a second DF result using the DF algorithm and the projected signal;
combine the first DF result and the second DF result to form a combined DF result; and
determine a location of a source of the received signal in the region using the combined DF result.

16. The computer storage medium of claim 15, wherein combining the first DF result and the second DF result to form a combined DF result further includes:
projecting the received signal onto another axis to form another projected signal, wherein the axis and the other axis are orthogonal;
generating a third DF result using the DF algorithm and the other projected signal; and
combining the first DF result, the second DF result, and the third DF result to form the combined DF result as a 3D DF result.

17. The computer storage medium of claim 15, wherein the first DF result includes a first heat map with a first band indicating a plurality of possible locations of the source of the received signal;
wherein the second DF result includes a second heat map with a second band indicating a plurality of possible locations of the source of the received signal;
wherein the combined DF result includes a third heat map that includes the first band and the second band; and
wherein determining the location of the source of the received signal in the region using the combined DF result includes identifying a portion of the third heat map where the first band and the second band intersect.

18. The computer storage medium of claim 15, wherein the computer-executable instructions, upon execution by a processor, further cause the processor to at least:
determine a portion of the received signal was received during a period when the diagonal antenna array was misaligned;
filter the determined portion out of the received signal to form a filtered signal; and
utilize the filtered signal to generate the first DF result and the second DF result.

19. The computer storage medium of claim 15, wherein the DF algorithm includes a Multiple Signal Classification (MUSIC) algorithm.

20. The computer storage medium of claim 15, wherein the plurality of antennas are positioned in the diagonal antenna array such that the antennas are separated by a freespace wavelength of the signals of interest divided by two (λ/2).
